(19) United States
(12) Patent Application Publication
(10) Pub. No.: US 2005/0268318 A1
(43) Pub. Date: Dec. 1, 2005

(54) Mobile power system

(75) Inventors: Michael Krieger, Miami Beach, FL (US); Kevin Ellsworth, Hollywood, FL (US)

Correspondence Address: VENABLE LLP, P.O. BOX 34385, WASHINGTON, DC, 20045-9998, US

(73) Assignee: Vector Products, Inc., Ft. Lauderdale, FL (US)

(21) Appl. No.: 11/116,419

(22) Filed: Apr. 28, 2005

Related U.S. Application Data
(60) Provisional application No. 60/565,853, filed on Apr. 28, 2004.

(51) Int. Cl. H04N 7/18

(52) U.S. Cl. 725/75

(57) ABSTRACT

The present invention is directed to a mobile power system. The mobile power system comprises a power inverter for receiving a DC input and providing an AC output, and a video display. The power inverter and the video display comprise an integrated unit.

### CROSS-REFERENCE TO RELATED APPLICATIONS

This application claims priority under 35 U.S.C. §119(e) of U.S. Provisional Patent Application No. 60/565,853, filed on Apr. 28, 2004, the entire content of which is incorporated herein by reference.

### BACKGROUND OF THE INVENTION

1. Field of the Invention

The present invention relates generally to mobile power systems for devices such as video games. More specifically, the present invention relates to such a mobile power system that includes an integrated video display.

2. Related Art

Many different types of electronic devices are now available that are designed to operate in a vehicle. The devices may be incorporated into the vehicle itself or may be portable, removable devices. The portable, removable electronic devices are typically designed to operate using the accessory 12 volt DC outlet, usually a cigarette lighter receptacle, that is generally provided in vehicles such as automobiles and minivans. Electronic devices, such as DVD players or television devices, are often attached to the back of the front seats of the vehicle so that passengers in the rear seats can view the video player or television device. Portable DVD players of the type generally described above are well known to those of ordinary skill in the art and currently available on the market.

Portable DVD players are capable of playing movies for entertainment purposes during long journeys in the vehicle. However, these portable DVD players do not typically have the capability for video game play. Video game players manufactured by Nintendo, Sega, Sony and others continue to grow in popularity each year. The ability to play these games during a long journey can provide a much needed form of entertainment and diversion for those on the trip. Using such video game players in a vehicle requires separate power supplies for the video game player and video display screen. The portable type video display screen typically is plugged into a 12 volt DC outlet cigarette lighter to receive a DC input, whereas the video game players typically require an AC input such as that provided from a typical wall outlet or by an inverter plugged into the cigarette lighter receptacle for producing the AC supply. These multiple adapters can clutter up the interior of a vehicle, and, if forgotten during the hectic moments of planning and packing for a long journey, render the video game player and/or display useless during the trip. Consequently, there is a need for a device that integrates a display and a power supply for the video game player in a single device.

### SUMMARY OF THE INVENTION

The present invention is directed to a mobile power system. According to one exemplary embodiment, the mobile power system comprises: a power inverter for receiving a DC input and providing an AC output; and a video display, wherein the power inverter and the video display comprise an integrated unit.

According to one aspect of the invention, the mobile power system can further include a player adapted to read at least one of a CD or a DVD, wherein the player comprises an integrated unit with the power inverter and the video display.

According to another aspect of the invention, the mobile power system can further include a rechargeable battery for providing DC power to at least one of the video display or the power inverter.

According to yet another aspect of the invention, the mobile power system can further include a docking station including a battery pack, wherein the docking station is adapted to provide electrical power to the integrated unit.

According to another exemplary embodiment of the invention, the mobile power system comprises: a housing; an input located on the housing to receive a DC input; a power inverter located in the housing to receive the DC input and to provide an AC output; a receptacle located on the housing to provide the AC output; and a video display located on the housing.

According to yet another exemplary embodiment of the invention, the mobile power system comprises: a DC input for receiving DC power from at least one of a DC plug adapted to be inserted in a cigarette lighter socket or an AC power adapter adapted to be inserted in an AC socket; a video display powered via the DC input; a video input port for providing a video signal to the video display; a power inverter for converting the DC input to an AC output; and an AC receptacle connected to the AC output; wherein the video display and the power inverter comprise an integrated unit.

Further objectives and advantages, as well as the structure and function of exemplary embodiments, will become apparent from a consideration of the following description and the appended drawings.

### BRIEF DESCRIPTION OF THE DRAWINGS

The foregoing and other features of the invention will be apparent from the following detailed description of exemplary embodiments of the invention, as illustrated in the accompanying drawings, wherein like reference numbers generally indicate identical, functionally similar, and/or structurally similar elements.

FIG. 1 is a perspective view of an exemplary embodiment of a power system according to the present invention in an open position;

FIG. 2 is a perspective view of the power system of FIG. 1 in an open position and attached to the rear of a car seat;

FIG. 3 is a perspective view of another exemplary embodiment of a power system according to the present invention in an open position;

FIG. 4 is a perspective view of another exemplary embodiment of a power system according to the present invention in a closed position;

FIG. 5 is another perspective view of the power system of FIG. 4 in a closed position;

FIG. 6 is another perspective view of the power system of FIG. 4 in a closed position;

FIG. 7 is a circuit schematic of an exemplary embodiment of the mobile power system of the present invention;

FIG. 8 is a circuit schematic of another exemplary embodiment of the mobile power system of the present invention; and

FIG. 9 is a perspective view of an exemplary embodiment of a power system according to the present invention, shown attached to a docking station.

### DETAILED DESCRIPTION OF THE INVENTION

Exemplary embodiments of the invention are discussed in detail below. In describing the embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

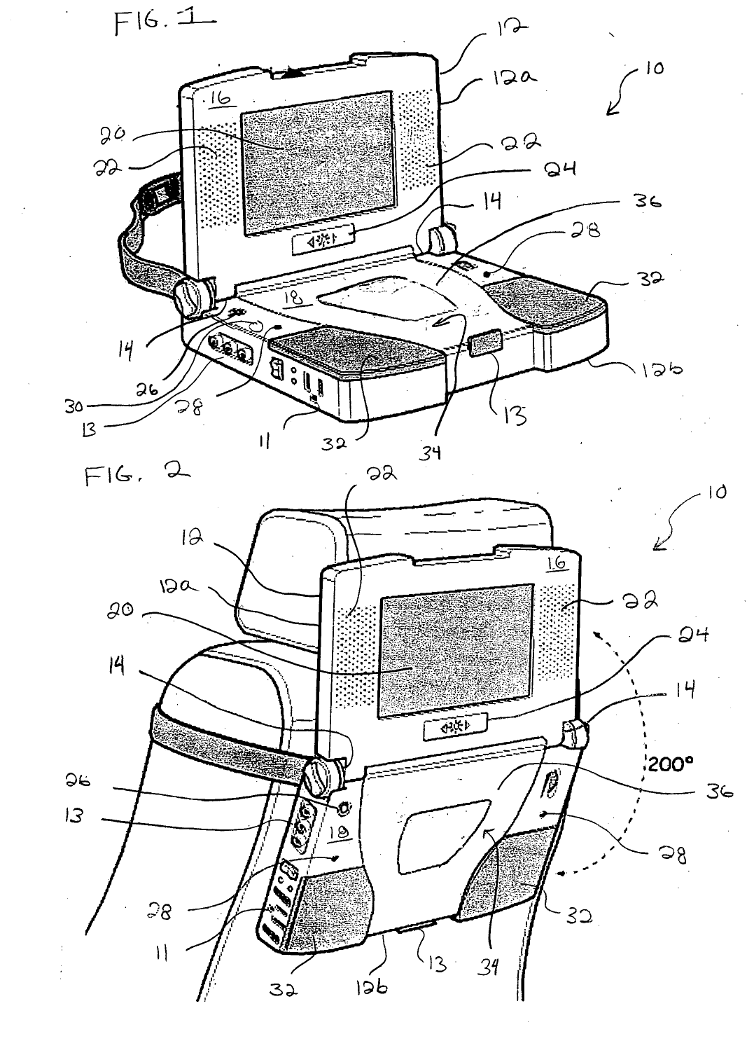

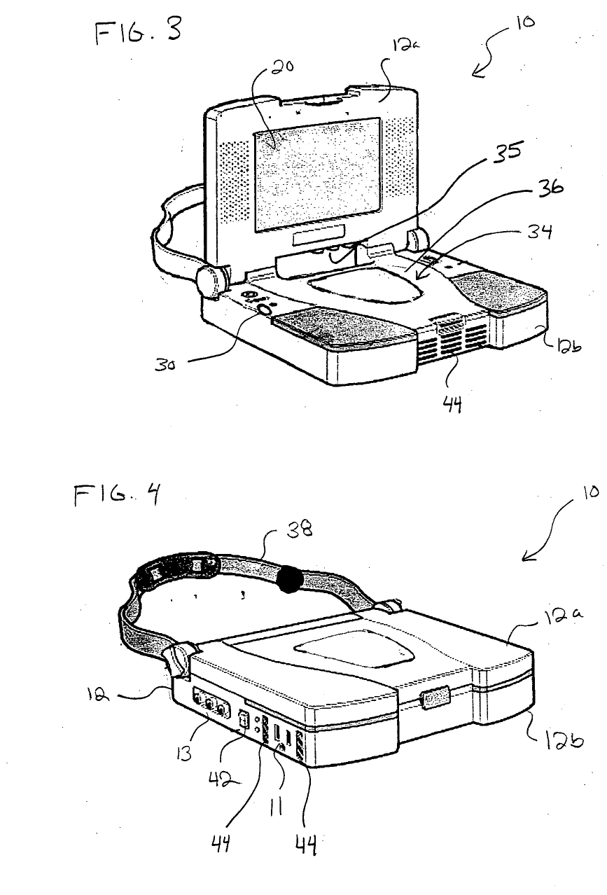

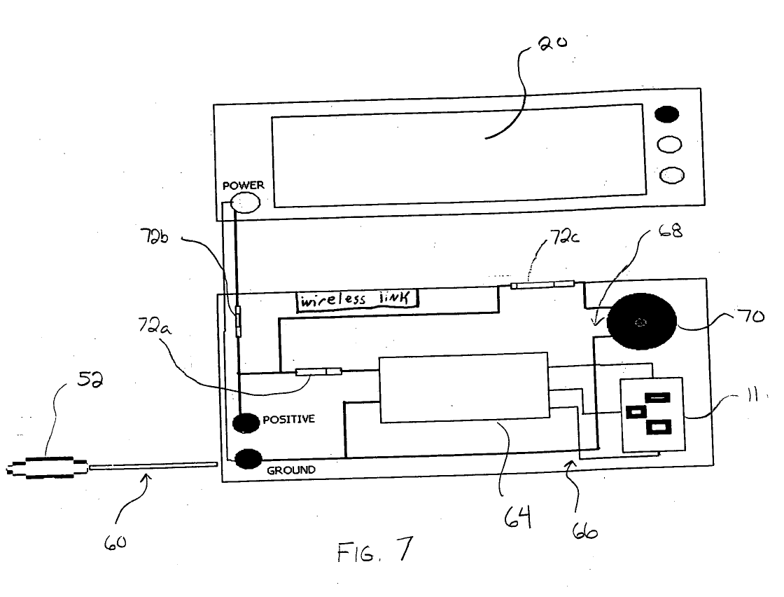

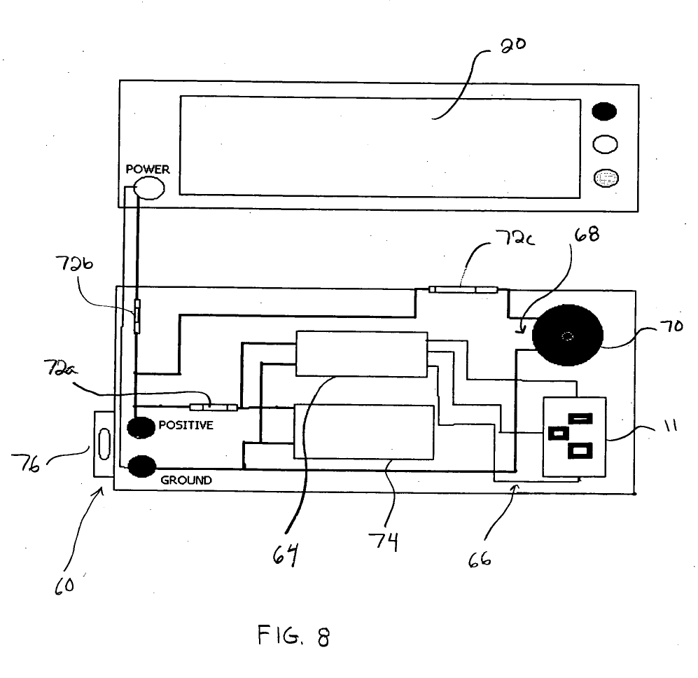

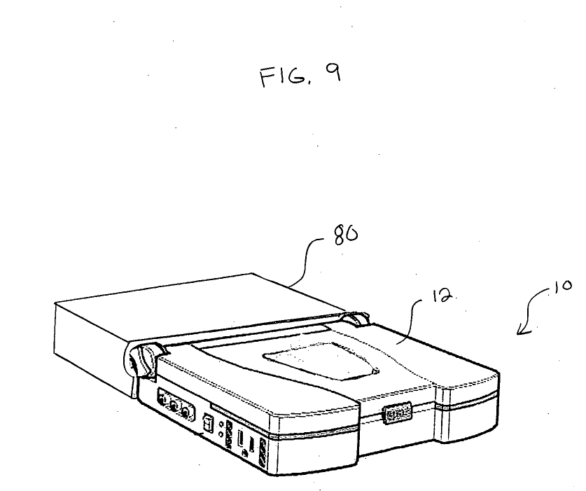

Referring to FIGS. 1 and 2, a first exemplary embodiment of a mobile power system according to the present invention is shown. The mobile power system 10 generally comprises a power inverter 64 (shown in FIGS. 7 and 8) and a video display 20 provided as an integrated unit. For example, the video display 20 and the power inverter 64 can both be located in the same housing 12. The housing 12 can include a single enclosure, or else multiple enclosures mechanically connected to one another, such as by hinges 14. Further details of the housing 12 are described below.

The power inverter receives a DC input and provides an AC output. The power inverter may be of a known construction, and can be adapted to produce a wide variety of power outputs, for example, 100 watts, 175 watts, 200 watts, etc.

The DC input can be provided by, for example, a cigarette lighter adapter plug, for using the power system 10 in a car, or a standard AC power adapter, for using the power system 10 in a house or other location having an AC receptacle.

The AC output from the power inverter 64 is provided to an AC receptacle 11 provided on housing 12. A video game player or other device can be plugged directly into the AC receptacle 11 in order to power that device. Accordingly, no separate power inverter, adapter plug, or other device may be necessary to power the video game player.

The system 10 can also serve as a display for the video game player. For example, the outputs of the video game player can be plugged into various RCA ports 13 that can be provided on the power system 10. In this manner, the video game player can be powered from the power system 10, and the video game can be displayed on the video display 20 that is integrated into the power system 10.

According to the exemplary embodiment shown in FIGS. 1 and 2, the housing 12 has an upper portion 12a and a lower portion 12b. The upper and lower portions 12a, 12b are joined together via hinges 14, about which the upper and lower portions 12a, 12b can rotate with respect to one another. The upper and lower portions 12a, 12b can be moved between various open positions, and a closed position (shown, for example, in FIGS. 3-6). FIG. 1 illustrates the system 10 in an open position with the upper portion 12a of the housing 12 arranged substantially perpendicularly to the lower portion 12b of the housing 12. The system 10 may be arranged in this position, for example, when it rests on the lap of a user. FIG. 2 illustrates the system 10 in an open position with the upper portion 12a oriented at an angle of about 200° with respect to the lower portion 12b. The system 10 may be arranged in this position, for example, when it is attached the to back of a car seat, as shown in FIG. 2.

Still referring to FIGS. 1 and 2, the upper portion 12a of the housing 12 includes a bottom face 16 which opposes a top surface 18 of the bottom portion 12b of the housing 12. The video display 20 may be located in the upper portion 12a of the housing 12. For example, the video display 20 can be located on the bottom face 16 of upper portion 12a. The video display 20 may be of any type known to one of ordinary skill in the relevant art, for example, a liquid crystal display (LCD) or a thin film transistor (TFT) display. The size of the video display 20 can vary and will depend on the size of the housing 12.

One or more speakers 22 may be provided, for example, on the bottom face 16 on either side of the video display 18. The speakers 22 can be used to provide the audio that accompanies the video shown on the video display 20. Alternatively, the speakers 22 may be used independently from the video to listen to a compact disc or other audio file provided, for example, by a DVD/CD player integrated into the housing 12 as described below. A control panel 24 can also be provided on the housing 12, for example, on the upper portion 12a. The control panel 24 can include various push buttons or other controls that are used to adjust the characteristics of the video display 20 and/or speakers 22. These controls may include the ability to adjust the brightness, contrast, size, etc., of the images shown on the video display 20, and/or the volume, treble, bass, etc. of the speakers 22.

The top surface 18 of the bottom portion 12b of the housing 12 may include a power button 26 that is used to turn the system 10 on and off. One or more ear phone jacks 28 (two are shown in FIGS. 1 and 2) may be provided on opposite sides of the top surface 18 to allow headphones to receive the audio output from the system 10. A separate volume control button may be provided for each earphone jack, or a single button may be provided to control the volume for both sets of earphones. Also, a wireless audio link 30 may be provided for a wireless connection to headphones or other audio devices.

Two padded surfaces 32 can be provided on the top surface 18 of the bottom portion 12b and can be used, for example, as hand rests.

Still referring to FIGS. 1 and 2, the system 10 may also include a DVD/CD player that is connected to the video display 20 and/or speakers 22. In the exemplary embodiment shown in FIGS. 1 and 2, a major portion of the lower portion 12b is occupied by DVD/CD player 34. The DVD/CD player 34 may be used to play DVDs, CDs, video games, etc. A cover 36 can be provided to enclose the portion of the system 10 where the DVD/CD is received. Accompanying controls 35 (shown in FIG. 3) for operation of the DVD/CD player 34 may be provided on the bottom portion 12b of the housing 12. The controls, as well as the DVD/CD player 34, may be protected by the cover 36 when in the closed position, as shown in FIGS. 1 and 2. Alternatively, the controls 35 may be exposed when the cover 36 is in the closed position, as shown in FIG. 3.

The lower portion 12b of the housing 12 also includes a bottom surface (not shown in the Figures) that is opposite top surface 18. The bottom surface may be covered with a padded rubber bottom or other surface. This surface may provide a non-slip surface to provide stabilization of the system 10 when used in a vehicle. The surface may also provide protection for the housing 12.

Still referring to FIGS. 1 and 2, the system 10 can include an adjustable strap 38 that may be connected to the housing 12. The strap 38 may be a flexible band strap that is adjustable to different sizes. The adjustable strap 38 may be used to transport the system 10. In addition, as shown in FIG. 2, the strap 38 may be used to secure the system 10 to the seat of an automobile. When used for this purpose, the strap 38 extends around the front and side portions of the seat to secure the system 10 to the rear of the seat. This allows passengers in the back seats of the vehicle to view the display 20. As mentioned above, the upper and lower portions 12a, 12b of the housing 12 can be connected by hinges 14 that provide at least 200° of rotation between the upper and lower portions 12a. This may allow the housing 12 to conform to the contour of the seat. In addition, the hinges 14 can include a securing means, such as a twist lock, that allows the upper and lower housing portions 12a, 12b to be secured in a selected position with respect to one another.

FIGS. 4-6 illustrate the system 10 with the upper and lower portions 12a, 12b of the housing 12 in a closed position. The closed position may be used, for example, when transporting the system 10. When the system 10 is in the closed position, the adjustable strap 38 may also be used as a shoulder strap to carry the system 10. The securing means, such as the twist lock, may be used to secure the upper and lower portions 12a, 12b of the housing 12 in the closed position. Additionally or alternatively, latch 40 may be provided to hold the upper and lower portions 12a, 12b in the closed position.

As shown in FIG. 4, the lower portion 12b of the housing 12 may include various input and output ports. For example, RCA ports 13 may be provided, such as video input, video output, audio input, and audio output ports. In addition, an AC output from the power inverter may be provided, for example, in the form of an AC receptacle 11. Additionally, controls 42 for the power inverter may be provided. Controls 42 can be used, for example, to turn the system 10 on or off. Vents 44 for cooling the power inverter may also be provided on the lower portion 12b of the housing 12.

FIG. 5 shows a view of the right-hand side of the system 10 in a closed position. According to the exemplary embodiment shown, an exhaust fan 46 may be provided proximate one or more of vents 44. The exhaust fan 46 and/or output vents 44 may be used to cool the components within the lower portion 12b of the housing 12.

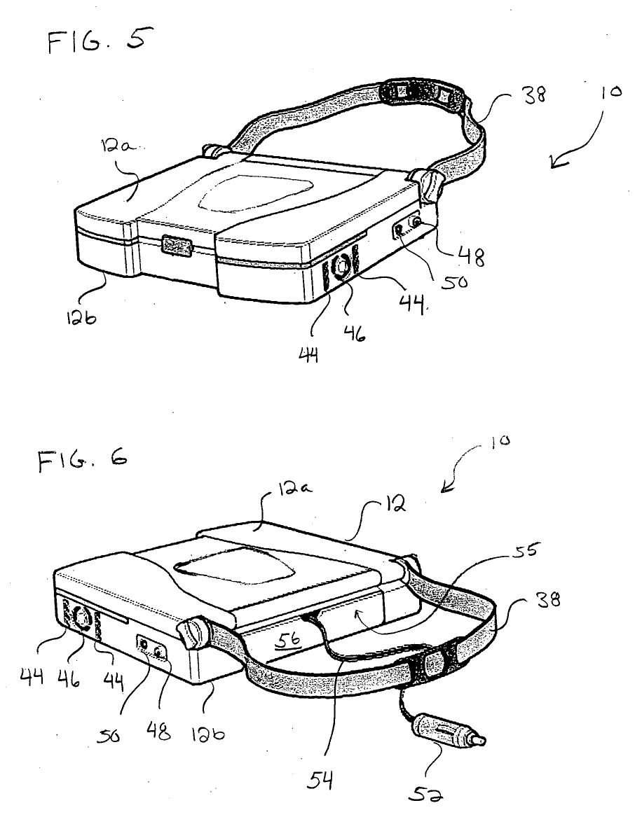

Referring to FIGS. 5 and 6, a video input port 48 may be provided to receive input from a video game, external DVD player, or other source, such that video from the external video device can be shown on display 20.

In addition, the system 10 may include a power input port 50 that is adapted to receive power for the various components. For example, the port 50 may be adapted to receive a pin of a standard AC adapter cube that is plugged into an AC wall outlet and provides a DC current at the pin. Additionally or alternatively, a DC input plug 52 may be provided. In the exemplary embodiment shown in FIG. 6, the DC plug 52 is a 12 volt DC plug adapted to be inserted into a cigarette lighter adapter of a vehicle, although other configurations are possible. A cord 54 can extend from the DC plug 52 to the interior of the housing 12 to the power inverter. The housing 12 may define a storage compartment 55 in which the DC 52 plug and its associated cord 54 may be stored. A cover 56 can be provided to facilitate access to the storage compartment.

FIG. 7 is a circuit diagram of one exemplary embodiment of the present invention. As shown, a DC input 60 can be provided via, for example, a 12-volt cigarette adapter plug 52. Plug 52 may be connected to an external power source, such as a cigarette lighter outlet in a car. Alternatively, DC input 60 can be provided from a standard AC adapter that is plugged into an AC wall socket in a house or other location.

The DC input 60 is connected to a power inverter 64 provided within the housing. The power inverter 64 receives the DC input 60 and converts it to an AC output 66, such as a 110-volt AC output similar to that provided from a typical household socket. The power inverter 64 may be adapted to provide, for example, 175 watts of power. The AC output 66 can be output to an AC receptacle 11 that is provided on the housing.

In the exemplary embodiment of FIG. 7, the video display 20 is powered by the DC input 60; however, the video display 20 can alternatively be powered from the AC output 66 of the power inverter 64.

A DC output 68 may also be provided, which may be coupled to the DC input 60, as shown in FIG. 7. The DC output may be provided, for example, by a 12-volt accessory socket 70 arranged on the housing. The accessory socket 70 may be adapted to receive a typical cigarette plug adapter. Fuses 72a, 72b, 72c may be provided in the circuit to protect the inverter 64, video display 20, and accessory socket 70, respectively, from potentially damaging electrical loads.

FIG. 8 is a circuit diagram of another exemplary embodiment of the present invention. In this embodiment, both a power inverter 64 and a rechargeable battery 74 are provided within the housing. The battery 74 may be of the 12-volt variety, for example. The battery 74 can be connected to a DC input, such as DC power port 76. DC power port 76 can receive DC power from a 12-volt cigarette lighter in a car, or alternatively, from a standard AC adapter. The 12-volt accessory socket 70 can alternatively serve as the DC input. The battery 74 can be charged by the DC input 60.

The battery 74 can be connected to the video display 20 in order to provide a power source to the video display 20. Accordingly, the mobile power system does not always need to be attached to an external power source in order operate the video display 20. This embodiment also includes a power inverter 64 similar to that described in conjunction with FIG. 7. Accordingly, the system 10 can provide an AC output 66, via AC receptacle 11. The battery 74 can provide DC power to the power inverter 64 to produce an AC output 66 at receptacle 11 when the system 10 is not attached to an external power source, thus allowing both the video display 20 and a video game plugged into receptacle 11 to operate off of battery 74. This may be advantageous when an external power source, such as a cigarette lighter outlet in a vehicle, or an AC wall receptacle in a house, is not available.

Referring back to FIGS. 5 and 6, a cooling fan 46 may be provided in the housing 12. The cooling fan 46 may be arranged to cool the power inverter and/or any other components within the housing 12. According to one exemplary embodiment, input vents are provided on one side of the housing 12, and output vents 44 are provided on an opposite side of the housing 12. The fan 46 can be arranged within the housing 12 to draw air into the housing 12 through the input vents, across the components to be cooled, and out of the housing 12 via the output vents 44. A small DC motor may be provided to power the fan 46. The DC motor may be powered by the DC input from the adapter plug, or DC input, or the internal battery of the system 10.

Referring to FIG. 9, the system 10 can be adapted to fit into a docking station 80. The docking station 80 can include a rechargeable battery pack (hidden from view). Contacts can be provided on the housing 12, and mating contacts can be provided on the docking station 80. The mating contacts can provide power from the battery pack to the system 10, such that the battery pack in the docking station 80 may be used to provide power to one or more of the various components within the housing 12. Accordingly, the system 10 can be used in essentially any location, without the need for a separate, external power supply. The docking station 80 can include input ports and associated circuitry that allow the battery pack to be recharged. The docking station can also include output ports that allow various peripherals, such as a monitor and/or speakers to be attached to the system 10 through the docking station 80.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A mobile power system comprising:
a power inverter for receiving a DC input and providing an AC output; and
a video display, wherein the power inverter and the video display comprise an integrated unit.

2. The mobile power system of claim 1, further comprising a player adapted to read at least one of a CD or a DVD, wherein the player comprises an integrated unit with the power inverter and the video display.

3. The mobile power system of claim 1, wherein the AC output is an AC receptacle located on the integrated unit.

4. The mobile power system of claim 1, further comprising a plug for a cigarette lighter socket to provide the DC input.

5. The mobile power system of claim 1, further comprising an AC power adapter to provide the DC input.

6. The mobile power system of claim 1, further comprising a video input port for communicating a video signal to the video display.

7. The mobile power system of claim 1, wherein the video display is powered via the DC input.

8. The mobile power system of claim 1, wherein the video display is powered via the AC output of the power inverter.

9. The mobile power system of claim 1, further comprising a rechargeable battery for providing DC power to at least one of the video display or the power inverter.

10. The mobile power system of claim 1, wherein the integrated unit comprises a housing for the video display and the power inverter.

11. The mobile power system of claim 10, wherein the housing includes an upper portion and a lower portion, and the video display is located on the upper portion and the power inverter is located in the lower portion.

12. The mobile power system of claim 1, further comprising a docking station including a battery pack, wherein the docking station is adapted to provide electrical power to the integrated unit.

13. A mobile power system comprising:
a housing;
an input located on the housing to receive a DC input;
a power inverter located in the housing to receive the DC input and to provide an AC output;
a receptacle located on the housing to provide the AC output; and
a video display located on the housing.

14. The mobile power system of claim 13, further comprising a player mounted in the housing and adapted to read at least one of a CD or a DVD.

15. The mobile power system of claim 13, further comprising a plug for a cigarette lighter socket to provide the DC input.

16. The mobile power system of claim 13, further comprising an AC power adapter to provide the DC input.

17. The mobile power system of claim 13, further comprising a video input port for communicating a video signal to the video display.

18. The mobile power system of claim 13, wherein the video display is powered via the DC input.

19. The mobile power system of claim 13, wherein the video display is powered via the AC output of the power inverter.

20. The mobile power system of claim 13, further comprising a rechargeable battery for providing DC power to at least one of the video display or the power inverter.

21. The mobile power system of claim 13, further comprising a docking station including a battery pack, wherein the docking station is adapted to provide electrical power to the DC input.

22. The mobile power system of claim 13, wherein the housing includes an upper portion and a lower portion, and the video display is located on the upper portion and the power inverter is located in the lower portion.

23. A mobile power system comprising:
a DC input for receiving DC power from at least one of a DC plug adapted to be inserted in a cigarette lighter socket or an AC power adapter adapted to be inserted in an AC socket;
a video display powered via the DC input;
a video input port for communicating a video signal to the video display;
a power inverter for converting the DC input to an AC output; and
an AC receptacle connected to the AC output;
wherein the video display and the power inverter comprise an integrated unit.

24. The mobile power system of claim 23, further comprising a video output port.

25. The mobile power system of claim 23, further comprising a player adapted to read at least one of a CD or a DVD, wherein the player comprises an integrated unit with the power inverter and the video display.

26. The mobile power system of claim 23, further comprising a rechargeable battery for providing DC power to at least one of the video display or the power inverter.

27. The mobile power system of claim 23, wherein the integrated unit comprises a housing for the video display and the power inverter.

28. The mobile power system of claim 27, wherein the housing includes an upper portion and a lower portion, and the video display is located on the upper portion and the power inverter is located in the lower portion.

29. The mobile power system of claim 23, further comprising a docking station including a battery pack, wherein the docking station is adapted to provide electrical power to the integrated unit.
